(19) United States
(12) Patent Application Publication
(10) Pub. No.: US 2023/0347313 A1
(43) Pub. Date: Nov. 2, 2023

(54) SOLAR-THERMAL CATALYTIC REACTOR

(71) Applicant: National Technology & Engineering Solutions of Sandia, LLC, Albuquerque, NM (US)

(72) Inventors: Christopher Ryan Riley, Albuquerque, NM (US); Kenneth Miguel Armijo, Albuquerque, NM (US); Clifford K. Ho, Albuquerque, NM (US)

(21) Appl. No.: 18/141,591

(22) Filed: May 1, 2023

Related U.S. Application Data
(60) Provisional application No. 63/337,512, filed on May 2, 2022.

(51) Int. Cl. B01J 19/12; B01J 31/14; F24S 23/74; F24S 20/30

(52) U.S. Cl. CPC B01J 19/127; B01J 31/143; F24S 23/74; F24S 20/30; B01J 2219/0871

(57) ABSTRACT

A gas processing system includes an input gas supply, an output gas storage container and/or an inlet to a secondary reactor, and a solar-thermal reactor. The solar-thermal reactor uses a solar collector to focus sunlight onto a reactor, the reactor having a housing that encloses a reaction chamber, a catalyst arranged therein, an inlet for receiving the input gas and an outlet for expelling the output gas. Sunlight is focused by the solar collector to heat the reactor and thereby chemically convert the input gas from the gas supply into the output gas that can be stored in the output gas container or directed towards the secondary reactor.

### RELATED APPLICATION

The present application claims the benefit of U.S. Provisional Application No. 63/337,512, filed on May 2, 2022, and entitled “SOLAR-THERMAL CATALYTIC REACTOR,” the entirety of which is incorporated herein by reference.

### STATEMENT OF GOVERNMENTAL INTEREST

This invention was made with Government support under Contract No. DE-NA0003525 awarded by the United States Department of Energy/National Nuclear Security Administration. The U.S. Government has certain rights in the invention.

### FIELD OF THE INVENTION

The technologies described herein relate to the in situ conversion of natural gas and, in particular, to a solar thermal catalytic reactor for in situ conversion of natural gas.

### BACKGROUND

Drilling for oil extracts other hydrocarbon compounds along with crude oil—in particular, natural gas or methane is common in oil deposits and is extracted as a gas alongside the liquid crude oil. While oil rigs are well-equipped to capture and store the extracted oil, extracted hydrocarbon gasses are combusted or “flared-off” due to a lack of cost-effective recovery and/or upgrading infrastructure on-site. (FIGS. 1 and 2 show conventional sea-based and land-based oil rigs 10 that each use a flaring-off system 20 to dispose of gaseous byproducts of the oil drilling process.) Oil rigs are typically located in remote locations that make it cost prohibitive to capture and process the natural gas on-site or to transport the extracted gas to a gas pipeline. Consequently, in the United States alone, well over 1 billion cubic feet of natural gas—with an approximate value of $2 million—is flared-off every day. Not all of the extracted natural gas is burned by the flaring-off process; an estimated 8 million tons of methane were emitted domestically in 2020 due to gas line leaks and flaring-off inefficiencies. To curb the potential environmental impacts of this practice, legislation has recently been proposed that would impose fees of up to $1500 per ton of natural gas flared-off or otherwise emitted. The creation of carbon dioxide from the combustion of natural gas has also been considered as a harmful byproduct of the flaring-off process. There are currently no suitable technologies for affordably processing extracted natural gas on-site to address the economic and environmental costs of continuing to flare-off extracted natural gas.

### SUMMARY

The following is a brief summary of subject matter that is described in greater detail herein. This summary is not intended to be limiting as to the scope of the claims.

A gas processing system includes an input gas supply, an output gas storage container, and a solar-thermal reactor. The solar-thermal reactor uses a solar collector to focus sunlight onto a reactor, the reactor having a housing that encloses a reaction chamber, a catalyst arranged therein, an inlet for receiving the input gas and an outlet for expelling the output gas. Sunlight is focused by the solar collector to heat the reactor and thereby chemically convert the input gas from the gas supply into the output gas that can be stored in the output gas container or fed into a secondary reactor downstream for further processing.

A method of processing an input gas includes the steps of focusing sunlight with a solar collector to heat a reactor to a reaction temperature, supplying an input gas to the heated reactor, generating an output gas by chemically reacting the input gas in the heated reactor in the presence of a catalyst contained therein, and storing the output gas in a gas storage container or fed into a secondary reactor downstream for further processing.

A method of making a gas processing system includes the steps of packing a catalyst into a reaction chamber of a reactor, connecting a gas supply to an inlet of the reactor, connecting an outlet of the reactor to a gas storage container, and positioning a solar collector to focus sunlight onto the reactor. The sunlight focused onto the reactor heats the catalyst to a reaction temperature.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is an illustration of a conventional system for flaring-off natural gas extracted by a sea-based oil rig;

FIG. 2 is an illustration of a conventional system for flaring-off natural gas extracted by a land-based oil rig;

FIG. 3 is a schematic illustration of an exemplary gas processing system;

FIG. 4 is a cross-sectional view of an exemplary solar-thermal reactor;

FIG. 5 is a cross-sectional view of the reactor thereof;

FIG. 6 is a graph of the temperature over time in the reaction chamber thereof;

FIG. 7 is a cross-sectional view of an exemplary solar-thermal reactor having multiple stages;

FIG. 8 is a cross-sectional view of an exemplary solar-thermal reactor having multiple stages;

FIG. 9 is a cross-sectional view of an exemplary solar-thermal reactor having multiple stages;

FIG. 10 is a cross-sectional view of an exemplary solar-thermal reactor having multiple stages;

FIG. 11 is a cross-sectional view of an exemplary solar-thermal reactor having multiple stages;

FIG. 12 is a cross-sectional view of an exemplary solar-thermal reactor having multiple stages;

FIG. 13 is a cross-sectional view of an exemplary solar-thermal reactor;

FIG. 14 is a cross-sectional view of the reactor thereof;

FIG. 15 is a cross-sectional view of an exemplary solar-thermal reactor;

FIG. 16 is a cross-sectional view of the reactor thereof;

FIG. 17 is a flow diagram that illustrates an exemplary methodology for operating an exemplary gas processing system; and

FIG. 18 is a flow diagram that illustrates an exemplary methodology for making an exemplary gas processing system.

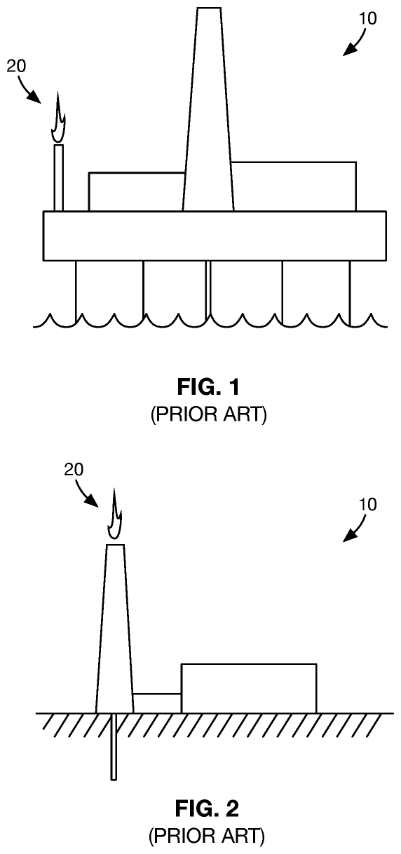

### DETAILED DESCRIPTION

Various technologies pertaining to gas processing and solar-thermal chemical reactors for performing gas processing are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Additionally, as used herein, the term “exemplary” is intended to mean serving as an illustration or example of something, and is not intended to indicate a preference.

The solar-thermal catalytic reactors described herein take advantage of the “free” energy provided by the sun to chemically convert input gasses—typically natural gas byproducts of the oil drilling process—using a dry reforming process and various downstream processes into a more usable and valuable form, such as, for example, synthesis gas (“syngas”) in a gaseous or liquid form, olefins, higher order hydrocarbons, and methanol. Importantly, the conversion of natural gas into syngas is performed in-situ at the drilling site so that the extracted gaseous byproducts of the drilling process are captured and converted into a useful material rather than being flared-off. Using solar energy as the primary means of supplying heat to the catalytic reactor that facilitates the chemical conversion of the natural gas allows the process to run in remote locations without electrical power supplied by a power grid. The application of the solar-thermal reactors described herein is not limited to the processing of natural gas and other gaseous byproducts of the drilling process. That is, the solar-thermal reactor described herein can be configured to facilitate a wide variety of chemical conversions by altering the catalyst provided in the reactor and the heat provided to the reactor by a solar collector.

In exemplary solar-thermal reactors described herein, the conversion of methane (the primary constituent of natural gas) is performed through the dry reforming of methane reaction (DRM) which converts methane and carbon dioxide into synthesis gas, a mixture of carbon monoxide and hydrogen. By using the solar-thermal reactors described herein, DRM can be performed in decentralized facilities at much milder temperatures and pressures than steam reforming conventionally performed at large, centralized chemical plants. The DRM reaction can be facilitated with a compositionally complex, multi-cationic aluminate spinel catalyst, as described in U.S. patent application Ser. No. 18/138,420, filed on Apr. 24, 2023, entitled “MULTI-CATIONIC ALUMINATE SPINELS” (“the '420 application”), the entirety of which is incorporated herein by reference. These catalysts simultaneously achieve the thermal stability, product selectivity, and catalytic activity necessary to efficiently convert methane and carbon dioxide into synthesis gas. DRM can be coupled with downstream processes to convert synthesis gas into a myriad of hydrocarbons, including olefins and methanol. Carbon dioxide co-reactant is already widely injected into oil and natural gas reserves through enhanced oil recovery (EOR) and enhanced gas recovery (EGR) processes and is therefore readily available for use in the solar-thermal reactors described herein.

The DRM reaction is highly endothermic and thus requires relatively high reaction temperatures. Generating energy to heat a reactor to the necessary reaction temperature via fossil fuel combustion adds to greenhouse gas emission and is costly. Instead, the exemplary gas processing systems described herein can use a solar collector to focus solar radiation onto a solar-thermal reactor to heat catalyst contained therein to a desired reaction temperature—e.g., a reaction temperature in a range of about 500 degrees Celsius to about 900 degrees Celsius. The solar-thermal reactors described herein can be built at relatively low-cost and can be transportable, thereby facilitating decentralized chemical production from underutilized hydrocarbon resources.

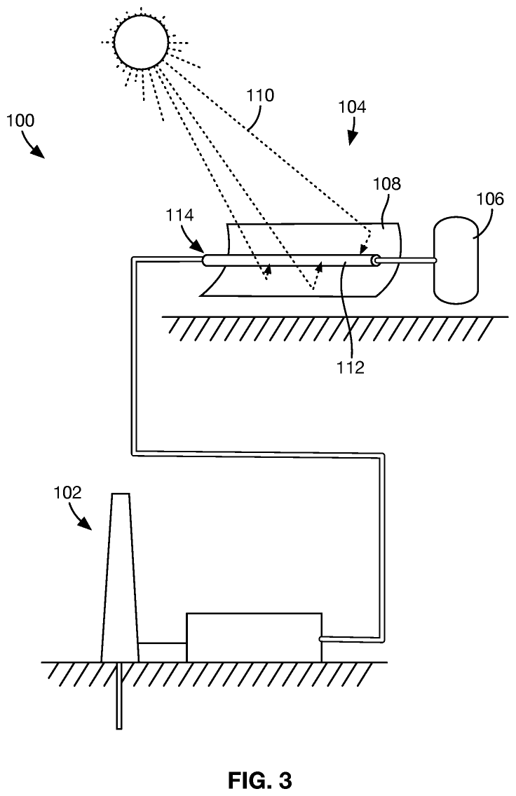

Referring now to FIG. 3, an exemplary in-situ natural gas processing system 100 that facilitates the chemical conversion of the gaseous by-products of drilling into useful chemical products is illustrated. An input gas to be processed by the in-situ natural gas processing system 100 is supplied from a gas supply 102 that can be, for example, a drilling rig, a gas tank, or any other source of gas capable of being processed by the in-situ natural gas processing system 100. Input gas from the gas supply 102 (e.g., the illustrated drilling rig) flows into a solar-thermal reactor 104 to undergo chemical conversion into an output gas before being expelled from the solar-thermal reactor 104 and stored in an output gas storage container 106. The solar-thermal reactor 104 includes a solar collector 108 that focuses sunlight 110 toward a reactor 112 that is arranged in a focal region 114 of the solar collector 108. While the gas supply 102 is illustrated as a drilling rig, the input gas can be supplied from a wide variety of sources—such as, for example, a refinery or factory process. The capability of the gas processing system 100 to process input gas in situ by virtue of the use of solar radiation to heat the solar-thermal reactor 104 enables the use of the gas processing system advantageous in any location where supplying power to or distributing output gas from a gas processing system would be cost prohibitive.

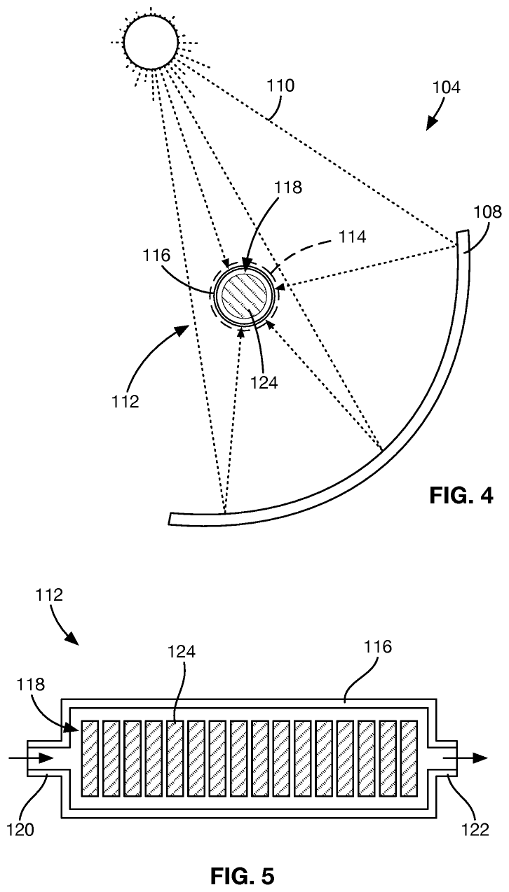

Referring now to FIGS. 4-5, an exemplary solar-thermal reactor 104 is illustrated. As can be seen in the transverse cross-sectional view illustrated in FIG. 4, sunlight 110 reflects off of the solar collector 108 and impinges on a focal region 114 in which the reactor 112 is positioned to directly heat the reactor 112 via the focused sunlight. The reactor 112 can be supported within the focal region 114 of the solar collector 108 in a wide variety of ways, such as, for example, by supports (not shown) attached to the solar collector 108, supports attached to a base (not shown), supports attached to a base and to the solar collector 108, or the like. The supports and base can be fixed or moveable so that the orientation of the solar collector 108 is fixed or can be moveable to track the sun throughout the day or to allow for seasonal adjustments. The solar collector 108 can have a fixed orientation chosen to capture as much sunlight 110 as possible throughout the day. In embodiments that include a moveable solar collector 108, an axis of rotation of the solar collector 108 can coincide with the focal region 114 so that the reactor 112 that is arranged within the focal region 114 does not need to move along with the solar collector 108.

The illustrated solar collector 108 has a curved surface that forms a trough-like shape. Curved solar collectors 108 are well known and can have a dish or bowl shape and have a wide variety of curved cross sections that focus sunlight into a focal region. For example, the solar collector 108 can be formed as a spherical mirror, a parabolic dish, a parabolic trough, or any other suitable curved surface that reflects sunlight into a focal region for heating the reactor 112. The solar collector 108 can also be a flat surface or an array of flat surfaces that reflect sunlight into the focal region 114. Though a curved trough-shaped solar collector is shown in FIG. 4, any combination of curved and flat surfaces can be used to redirect sunlight 110 toward the focal region 114 and the reactor 112 provided therein.

The illustrated reactor 112 includes a housing 116 formed from a tube of material that encloses a reaction chamber 118 to form what is known as plug flow reactor that facilitates a chemical reaction along the length of the pipe. The housing 116 has a wall thickness that is suitable for the length of the reactor 112 at the temperature resulting from sunlight 110 directed toward the reactor 112 from the solar collector 108. The housing 116 can be formed from a wide variety of materials that can be transparent or opaque, such as, for example, quartz, glass. In another example, the housing 116 is formed of a metal or metals, such as an alloy or alloys of steel (e.g., stainless steel). Other materials are also contemplated, such as alumina or silicon carbide. An inlet 120 is in fluid communication with the reaction chamber 118 at one end of the housing 116 and an outlet 122 is in fluid communication with the reaction chamber 118 at the other end of the housing 116. Inlet and outlet valves (not shown) can be provided to control the flow of gas through the reactor 112 and can be located at the gas supply 102 and gas storage container 106 and can be located near or attached to the inlet 120 and the outlet 122 of the reactor 112. The reactor 112 can optionally include a glass envelope (not shown) and an enclosed region that is under vacuum to prohibit convective and radiative heat losses.

Though the illustrated reactor 112 has a generally cylindrical shape and has a generally circular cross-sectional shape, the reactor 112 can take on a wide variety of shapes depending on the desired conditions for the chemical conversion of the input gas into the output gas as the input gas flows from the gas supply 104, through the inlet 120, through the reaction chamber 118, out of the outlet 122, and into the gas storage container 106. The shape of the reactor 112 can also be designed to correspond to the properties of the focal region 114 of the solar collector 108. For example, the solar collector 108 may focus sunlight 110 into a focal region 114 that has a generally elliptical cross-sectional shape so that forming the cross-sectional shape of the housing 116 of the reactor 112 to correspond to the shape of the focal region 114 may facilitate a more even heating of the reactor 112 and the reaction chamber 118.

The reactors 112 shown herein are depicted as a single tube extending through the focal region 114 of the solar collector 108. The diameter of the reaction chamber 118 and the pressure and temperature of the input gas determines the mass flow rate of the input gas through the reactor 112. The length of time that the input gas has to convert into the output gas is limited by the length of the reaction chamber 118 and the mass flow rate of the input gas through the reaction chamber 118. That is, increasing the diameter of the reaction chamber 118 allows more gas to flow through the reactor 112 in a given time, and lengthening the reaction chamber 118 allows for the gas to be heated and reacted over a longer time, depending on the flow rate of the gas. The amount of gas processed through the reactor 112 can also be increased while keeping the flow rate of the gas the same by arranging a plurality of housings 116 in parallel so that the reactor 112 includes more than one reaction chamber 118 for processing the input gas. Similarly, the time that the input gas spends in the reactor 112 can be increased without altering the flow rate of the gas or the overall length of the reactor 112 by forming the housing 116 into a tube that follows a spiral or other winding shape or that folds back on itself and passes through the focal region 114 of the solar collector 108 multiple times.

The reaction chamber 118 of the reactor 112 is packed with a catalyst 124 that is porous or in a form that provides sufficient space through which the input gas can flow—e.g., a powder-form catalyst suspended in a neutral, porous material, or a catalyst compressed into pellets or pucks that can be poured into or stacked in the reaction chamber 118. Sunlight 110 focused on the reactor 112 increases the temperature of the reaction chamber 118 and the catalyst 124 packed therein to a desired reaction temperature. The reaction temperature can be in a range of about 500 degrees Celsius to about 900 degrees Celsius, or in a range of about 750 degrees Celsius to about 775 degrees Celsius. The reaction temperature range can vary depending on the material used for the catalyst 124 and the supplied input gas.

The catalyst 124 can be any catalyst suitable for facilitating the chemical conversion of the input gas supplied from the gas supply 102 and any other gas sources that can be used to supplement the input gas supplied from the gas supply 102. For example, the input gas from the gas supply 102 can be the gaseous byproducts of oil drilling—i.e., natural gas that comprises methane—and a secondary gas, such as carbon dioxide can be supplied so that the natural gas and carbon dioxide react to form synthesis gas or “syn gas” consisting of hydrogen and carbon monoxide. Additional gasses like carbon dioxide can be supplied from a tank or other source; in the case of drilling for natural gas and oil, a supply of carbon dioxide is typically available as carbon dioxide is stored on site for use in the drilling operation. Catalyst materials that enable dry reforming of natural gas at the temperatures described herein are described in greater detail in the '420 application; it is to be understood, however, that other catalysts can be used and are contemplated.

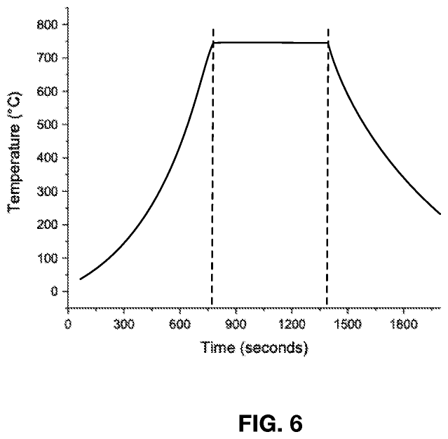

As is illustrated in FIG. 6, the temperature of the reactor 112 can be increased by exposing the reactor 112 to sunlight 110, maintained at a desired reaction temperature, and then be allowed to cool off as the reactor 112 is no longer exposed to focused sunlight 110 from the solar collector 108. The heat generated in the reactor 112 by the reflected light from the solar collector 108 can be adjusted in a wide variety of ways to heat the reactor 112 to a desired reaction temperature. For example, to increase the heat applied to the reactor 112, the size of solar collector 108 can be increased and vice versa for decreasing the heat applied to the reactor 112. The solar collector 108 can optionally include one or more attenuators (not shown) that block or redirect some or all of the sunlight 110 from reaching the solar collector 108 or the reactor 112 to reduce the temperature of the reactor 112 and/or control rate of change of temperature. The reactor 112 can also be altered along its length to increase or decrease the amount of energy absorbed by the reactor 112 from the sunlight 110 focused onto the reactor 112 by the solar collector 108. For example, a portion of the reactor 112 can be colored black with paint or other surface treatments to increase the quantity of light absorbed by the reactor 112 or can be colored white or made reflective to reduce the quantity of light absorbed by the reactor 112.

The chemical conversion of the input gas generates an output gas that is expelled from the reactor 112 via the outlet 122. As noted above, a single-stage reactor 112 using an aluminate spinel catalyst 124 can be used to convert natural gas and carbon dioxide into syn gas that can be compressed and stored in the gas storage container 106. The syn gas can also be fed into a secondary reaction process (not shown) in a second stage of the reactor 112 or in a separate reaction system to be converted into a wide variety of other useful materials. For example, the syn gas can be directed to a Fischer-Tropsch process to create a wide variety of useful hydrocarbon products, some of which are in liquid form and can be used on-site or transported by truck for sale or distribution elsewhere.

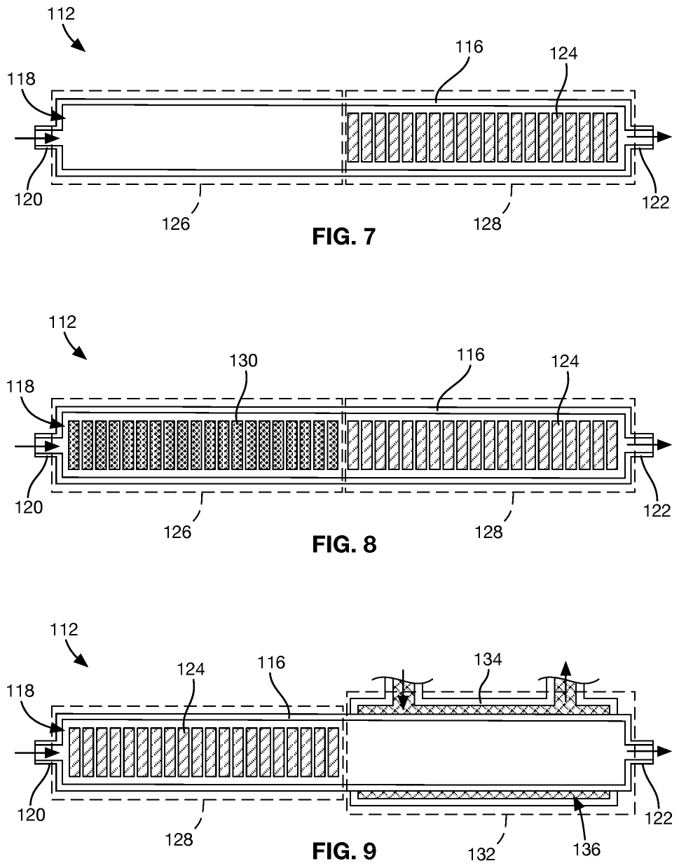

Referring now to FIGS. 7-12, various reactors 112 having multiple reactor stages are shown to demonstrate examples of the wide variety of configurations that are possible in the exemplary solar-thermal reactor 104. As explained herein, the tube-shape of the reactor 112 enables the parameters of the chemical reaction performed in the reaction chamber 118 to be adjusted along the length of the reactor 112. That is, the reactor 112 can include multiple reactor stages that include different reaction parameters to enable more efficient or different chemical conversion of the input gas. For example, the reactor 112 can include a pre-heating stage to bring the input gas up to a reaction temperature before reaching the catalyst 124, a second catalyst stage with a different catalytic material, or a cooling stage that reduces the temperature of the output gas to stop or slow the ongoing chemical reaction in the reaction chamber 118. While a variety of different combinations of reactor stages are shown in FIGS. 7-12, the illustrated combinations should not be seen as limiting the present disclosure to only the combinations shown. Rather, a wide variety of combinations of stages can be provided in the reactor 112 so that the reactor 112 can be tailored to a desired use case.

Referring now specifically to FIGS. 7-8, reactors 112 are illustrated that include multiple stages: a preheating stage 126 and a catalytic reaction stage 128. The preheating stage 126 allows the input gas to be heated up to or close to the reaction temperature so that the input gas begins reacting at the desired temperature, thereby increasing the efficiency of the reactor 112. The preheating stage 126 in FIG. 7 is an empty portion of the reaction chamber 118 where the input gas is allowed to mix and increase in temperature before encountering the catalyst 124 in the catalytic reaction stage 128. The preheating stage 126 shown in FIG. 8 includes an inert heat transfer media, such as packed silicon carbide, that facilitates heat transfer from the reactor 112 to the input gas.

Referring now to FIG. 9, a reactor 112 is illustrated that includes a cooling stage 132 arranged after the catalytic reaction stage 128. The cooling stage 132 can include various means described herein for reducing the amount of solar energy directed towards the cooling stage 132 of the reactor 112 and can also include a heat sink 134 that contains a heat transfer fluid 136 that is heated by the reactor 112 and then pumped from the heat sink 134 to a radiator or other heat dissipation device (not shown) where the heat transfer fluid 136 is cooled before returning to the heat sink 134 to extract more heat from the reactor 112. The cooling stage 132 can be used to reduce the temperature of the reactor 112 and thereby slow down or stop the chemical reaction of the input gas before the output gas reaches and is expelled from the outlet 122 of the reactor 112. The heat sink 134 can also be formed from a tube that coils around the housing 116 of the reactor 112, or have any other configuration suitable for facilitating heat transfer between the heat transfer fluid 136 and the reactor 112.

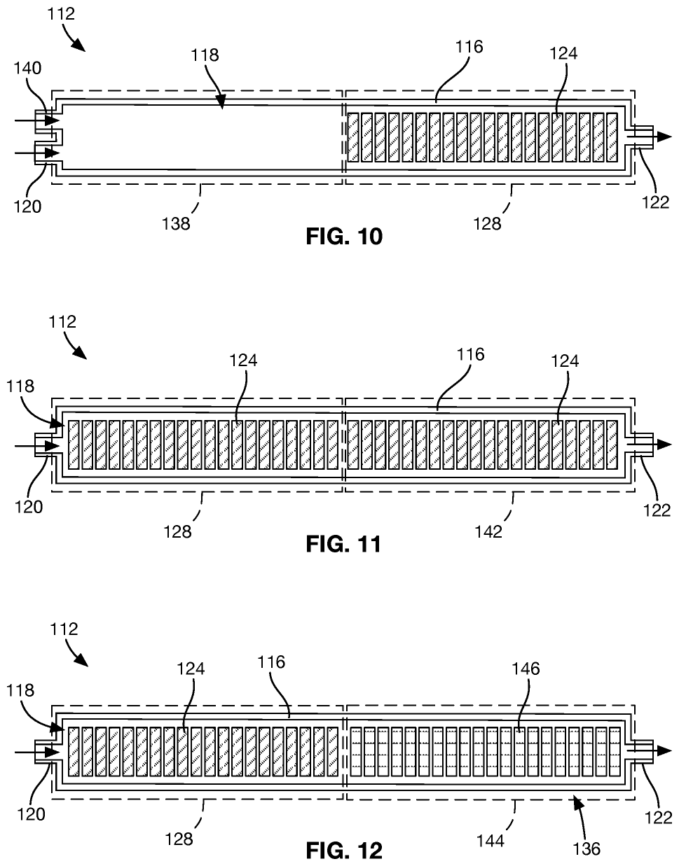

Referring now to FIG. 10, a reactor 112 is illustrated that includes a mixing stage 138 before the catalytic reaction stage 128. The reactor housing 116 also includes the inlet 120 and a second inlet 140 for supplying a second input gas to the reactor 112. The second input gas can be, for example, carbon dioxide that is mixed with natural gas from the inlet 120 in the mixing stage 138 to improve the efficiency of the chemical reaction of the input gasses in the catalytic reaction stage 128. The mixing stage 138 can also be a preheating stage 126 when solar energy or another heat source is applied to the reactor 112 in the location of the mixing stage 138.

Referring now to FIG. 11, a reactor 112 is illustrated that includes a second catalytic reaction stage 142 that follows the catalytic reaction stage 128. The same catalyst 124 is packed into the reaction chamber 118 for both of the catalytic reaction stages 128, 142. The catalytic reaction stages 128, 142 are heated to two different temperatures: the catalytic reaction stage 128 is heated to a first temperature and the second catalytic reaction stage 142 is heated to a second temperature. Thus, the parameters of the catalytic reaction undergone by the input gas can be altered between stages of the reactor 112 to increase efficiency or to produce different output gas than a reactor having a single stage with one reaction temperature throughout.

Referring now to FIG. 12, a reactor 112 is illustrated that includes a second catalytic reaction stage 144 with a second catalyst 146 that follows the catalytic reaction stage 128 with the catalyst 124. The reaction stages 128, 144 can be heated to the same or to different temperatures, depending on the desired chemical reaction and output gas. For example, the catalytic reaction stage 128 can be used to convert natural gas and carbon dioxide into syn gas, and the second catalytic reaction stage 144 can be used to convert the syn gas into a higher order hydrocarbon fluid. An optional inlet (not shown) can be provided through the housing 116 of the reactor 112 at the beginning of the second reaction stage 144 to provide an additional input gas to be mixed together and reacted with the output gas from the reaction stage 128 as the additional input gas and first output gas flow through the second reaction stage 144.

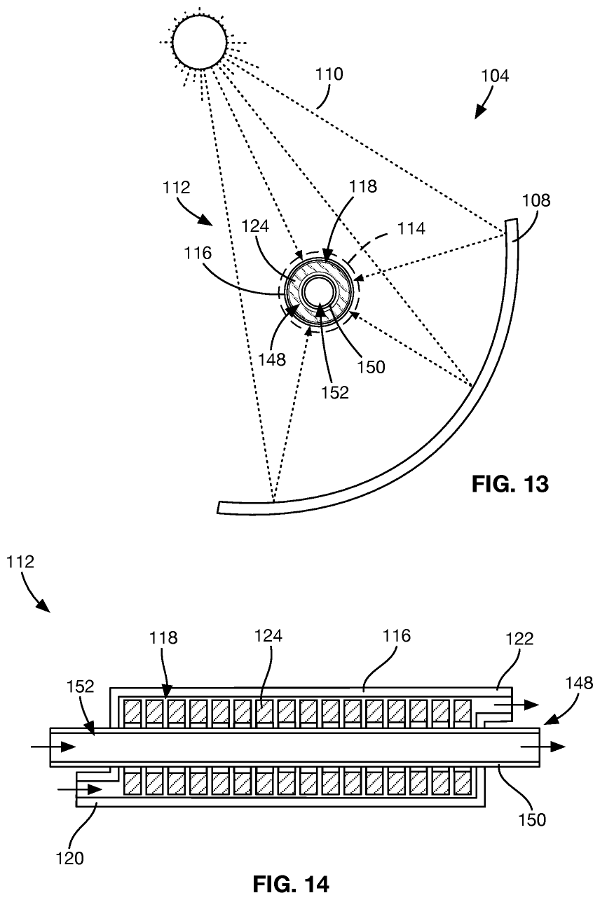

Referring now to FIGS. 13 and 14, solar-thermal reactors 104 are shown that include different or additional means of heating the reactor 112 to the desired reaction temperature. With reference to FIG. 13, the reactor 112 includes a supplemental or auxiliary heater 148 for providing heat to the reactor 112 when the sunlight 110 reflected by the solar collector 108 onto the reactor 112 cannot provide sufficient heat to maintain the reactor 112 at the desired reaction temperature (e.g., at night, during cloud cover, or when the ambient temperature and wind conditions mitigate transfer generated heat away from the reactor 112). The illustrated auxiliary heater 148 has a tube-shaped housing 150 that is arranged coaxially with and extends through the housing 116 of the reactor 112. The housing 150 encloses a heating chamber 152 through which a heating fluid is directed. The heating fluid can be a liquid heat transfer fluid that is heated outside of the solar-thermal reactor 104 and pumped through the auxiliary heater 148 to heat the reactor 112 and the catalyst 124. The heating fluid can also be combustion gasses supplied by a burner that burns some of the input gas— e.g., natural gas—to generate heat to heat the reactor 112 so that the remainder of the input gas can be chemically converted into the output gas. In a similar fashion, some of the output gas can be fed into a burner to provide hot combustion gasses to the auxiliary heater 148 after the reactor 112 has been heated sufficiently so that output gasses are generated. A control system (not shown) can be used to activate the auxiliary heater 148 in response to the temperature of the reaction chamber 118 and/or the energy output of the solar collector 108 has decreased below a predetermined threshold. The control system can also monitor the ambient temperature, wind, and other environmental factors such as the presence and amount of precipitation to determine when the auxiliary heater 148 should be used.

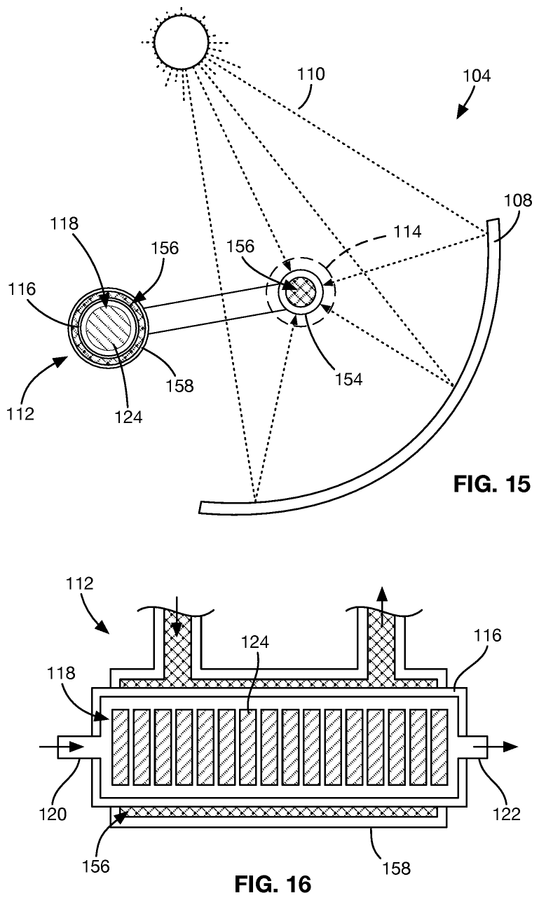

Now referring to FIGS. 15 and 16, the reactor 112 is arranged in a location that is remote from the focal region 114 of the solar collector 108 and a heat absorber 154 is positioned in the focal region 114 instead. Sunlight 110 is focused onto the heat absorber 154 to increase the temperature of a heat transfer fluid 156 contained therein. The heated heat transfer fluid 156 is then pumped by a pump (not shown) into a heater housing 158 that is coaxial with and surrounds the housing 116 of the reactor 112. The heater housing 158 can also be formed from a tube that coils around the housing 116 of the reactor 112 or has any other configuration suitable for facilitating heat transfer between the heat transfer fluid 156 and the reactor 112. The heat absorber 154 can have a tube or pipe shape that extends through the focal region 114 of the solar collector 108. Alternatively, the solar collector 108 can be formed in a flat arrangement of a plurality of evacuated tubes in which an array of heat absorbers 154 are arranged. The solar collector 108 can also have a dish shape for focusing sunlight 110 onto a heat absorber 154 shaped to fit within the focal region 114 of the dish.

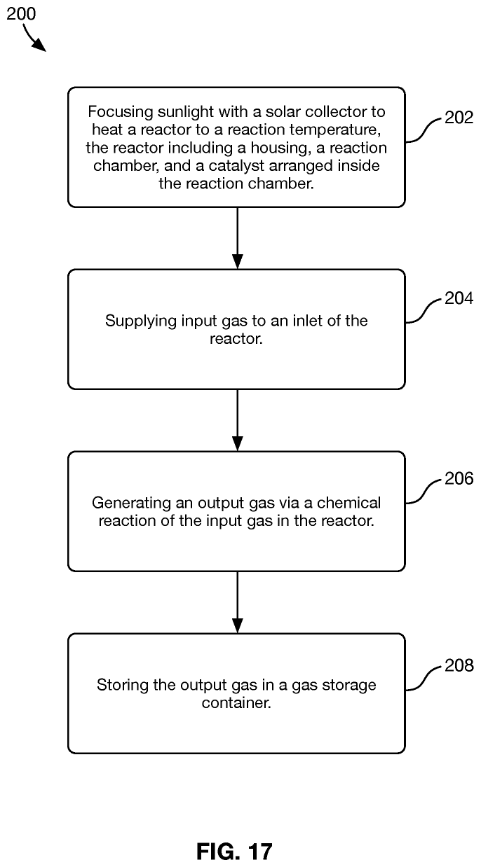

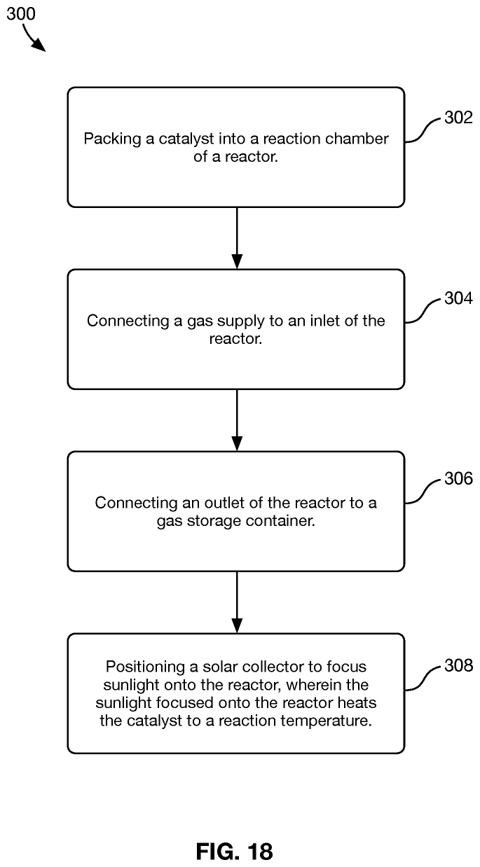

FIGS. 17 and 18 illustrate exemplary methodologies related to making and operating an in situ gas processing system, such as the gas processing system 100. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Referring solely to FIG. 17, a methodology 200 that facilitates the processing of an input gas—such as the gaseous byproducts of drilling—into a desired output gas is illustrated. The methodology 200 begins at 202 by focusing of sunlight with a solar collector to heat a reactor to a reaction temperature. The reactor can be any of the reactors described herein, and includes a housing enclosing a reaction chamber and a catalyst arranged therein. At 204, an input gas is supplied to an inlet of the reactor and at 206, an output gas is generated by the chemical reaction of the input gas in the presence of the catalyst in the reaction chamber of the reactor. The output gas is stored at 208 in a storage container. The methodology 200 can be performed using any of the solar-thermal reactors described herein.

Referring now to FIG. 18, a methodology 300 that facilitates the making of a gas processing system for processing an input gas—such as the gaseous byproducts of drilling—into a desired output gas is illustrated. The methodology 300 begins at 302 by packing a catalyst into a reaction chamber of a reactor. The reactor can be any of the reactors described herein. At 304, a gas supply is connected to an inlet of the reactor and an outlet of the reactor is connected to a gas storage container at 306. In 308, a solar collector is positioned to focus sunlight onto the reactor to heat the catalyst packed in the reaction chamber to a reaction temperature. The methodology 300 can be performed to manufacture any of the gas processing systems described herein.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gas processing system comprising:
an input gas supply;
at least one of an output gas storage container or a downstream reactor inlet;
a solar-thermal reactor comprising a solar collector and a reactor that is heated by the solar collector, the reactor comprising:
a housing having an inlet for receiving a hydrocarbon input gas and an outlet for expelling an output gas, wherein the inlet is in fluid communication with the input gas supply and the outlet is in fluid communication with the at least one of the output gas storage container or the downstream reactor inlet;
a reaction chamber enclosed by the housing and in fluid communication with the inlet and the outlet; and
a catalyst arranged inside the reaction chamber;
wherein the heat applied to the reactor by the solar collector heats the catalyst to a reaction temperature; and
wherein input gas flows from the input gas source and through the thermal reactor from the inlet to the outlet to be chemically converted into the output gas that is stored in the output gas storage container or directed to the downstream reactor inlet to a secondary reactor.

2. The gas processing system of claim 1, wherein: the catalyst comprises a multi-cationic aluminate spinel catalyst; the hydrocarbon input gas comprises methane and carbon dioxide; and the output gas comprises hydrogen and carbon monoxide.

3. The gas processing system of claim 1, wherein the solar collector is a parabolic trough solar collector and the reactor is arranged in a focal region of the parabolic trough solar collector.

4. The gas processing system of claim 1, wherein the housing is a tube formed from at least one of quartz, glass, steel, stainless steel, alumina, or silicon carbide.

5. The gas processing system of claim 1, wherein the solar collector is moveable and can be oriented to increase or decrease an amount of solar radiation focused into the focal region.

6. The gas processing system of claim 1, wherein the reactor comprises a preheating stage.

7. The gas processing system of claim 6, wherein an inert heat transfer media is arranged in the reaction chamber of the preheating stage.

8. The gas processing system of claim 1, wherein the reactor comprises a cooling stage that includes a heat sink.

9. The gas processing system of claim 1, wherein the reactor comprises a mixing stage comprising a first inlet and a second inlet.

10. The gas processing system of claim 1, wherein the reactor comprises a first stage that is heated to a first reaction temperature and a second stage that is heated to a second reaction temperature that is different from the first reaction temperature.

11. The gas processing system of claim 1, wherein the reactor comprises a first stage comprising a first catalyst and a second stage comprising a second catalyst.

12. The gas processing system of claim 11, wherein the first stage is heated to a first reaction temperature and the second stage is heated to a second reaction temperature that is different from the first reaction temperature.

13. The gas processing system of claim 1, wherein the reactor comprises an auxiliary heater comprising a housing that is coaxial with the reactor and that encloses a heating chamber, and wherein a heating fluid flows through the heating chamber to supply heat to the auxiliary heater.

14. The gas processing system of claim 13, wherein a heating fluid is generated by combusting the input gas.

15. The gas processing system of claim 1, further comprising:
a heat absorber arranged in a focal region of the solar collector;
a heater for heating the reactor; and
a heat transfer fluid that flows through the heat absorber and the heater.

16. A method of making gas processing system comprising:
packing a catalyst into a reaction chamber of a reactor;
connecting a gas supply to an inlet of the reactor;
connecting an outlet of the reactor to a gas storage container; and
positioning a solar collector to focus sunlight onto the reactor, wherein the sunlight focused onto the reactor heats the catalyst to a reaction temperature.

17. The method of claim 16, wherein: the catalyst comprises a multi-cationic aluminate spinel catalyst; an input gas supplied from the gas supply comprises natural gas and carbon dioxide; and an output gas formed by the chemical conversion of the input gas as the input gas flows through the reaction chamber comprises hydrogen and carbon monoxide.

18. A method of processing gas, the method comprising:
focusing sunlight with a solar collector to heat a reactor to a reaction temperature, the reactor including a housing, a reaction chamber, and a catalyst arranged inside the reaction chamber;
supplying input gas to an inlet of the reactor;
generating an output gas via a chemical reaction of the input gas in the reactor; and
storing the output gas in a gas storage container or directing the output gas to a secondary reactor.

19. The method of claim 18, wherein the step of generating an output gas comprises a dry reforming process and the catalyst comprises a multi-cationic aluminate spinel catalyst.

20. The method of claim 19, wherein the input gas comprises natural gas and carbon dioxide and the output gas comprises hydrogen and carbon monoxide.
